(19) United States
(12) Patent Application Publication
(10) Pub. No.: US 2016/0063122 A1
(43) Pub. Date: Mar. 3, 2016

(54) EVENT SUMMARIZATION

(71) Applicant: HEWLETT-PACKARD DEVELOPMENT COMPANY, L.P., Houston, TX (US)

(72) Inventors: Sitaram Asur, Palo Alto, CA (US); Freddy Chong Tat Chua, Palo Alto, CA (US)

(21) Appl. No.: 14/784,087

(22) PCT Filed: Apr. 16, 2013
(86) PCT No.: PCT/US13/36745

§ 371 Date: Oct. 13, 2015

(51) Int. Cl. G06F 17/30

(52) U.S. Cl. CPC G06F 17/30867; G06F 17/3053; G06F 17/30598; G06F 17/30551

(57) ABSTRACT

Event summarization can include extracting Content from an unfiltered social media content associated with an event. Event summarization can also include constructing a summary of the event based on the extracted content.

### BACKGROUND

Social media websites provide access to public dissemination of events (e.g., a concept of interest) through opinions and news, among others. Opinions and news can be posted on social media websites as text by users based on the event with which the users may be familiar.

The posted text can be monitored to detect real world events by observing numerous streams of text, Due to the increasing popularity and usage of social media, these streams of text can be voluminous and may be time-consuming to read by a user,

### BRIEF DESCRIPTION OF THE DRAWING

FIG. 1 is a block diagram illustrating an example of a method for event summarization according to the present disclosure.

FIG. 2 is a block diagram illustrating an example of a method for event summarization according to the present disclosure.

FIG. 3 is a block diagram illustrating an example of topic modeling according to the present disclosure.

FIG. 4 illustrates an example system according to the present disclosure.

### DETAILED DESCRIPTION

Event detection systems have been proposed to detect events on social media streams such as Twitter and/or Facebook, but understanding these events can be difficult for a human reader because of the effort needed to read the large number of social media content (e.g., tweets, Facebook posts) associated with these events. An event can include; for example, a concept of interest that gains people's attention (e.g., a concept of interest that gains attention of a user of the social media). For instance; an event can refer to an unusual occurrence such as an earthquake, a political protest, or the launch of a new consumer product, among others.

Social media websites such as Twitter provide quick access to public dissemination of opinions and news. Opinions and news can be posted as short snippets of text (e.g., tweets) on social media websites by spontaneous users based on the events that the users know. By monitoring the stream of social media content, it may be possible to detect real world events from social media websites.

When an event occurs, a user may post content on a social media website about the event, leading to a spike in frequency of content related to the event. Due to the increased number of content related to the event, reading every piece of content to understand what people are talking about may be challenging arid/or inefficient.

Prior approaches to summarizing events include text summarization, micro-blog event summarization, and static decay functions, for example. However, in contrast to prior approaches, event summarization according to the present disclosure can include the use of the temporal correlation between tweets, the use of a set of content (e.g., a set of tweets) to summarize an event, summarizing without mining hashtags, summarizing a targeted event of interest, and summarizing an event while considering decreased amounts of content (e.g., short tweets or posts), among others.

For example, event summarization according to the present disclosure can address summarizing a targeted event of interest (e.g., for a human reader) by extracting representative content from an unfiltered social media content stream for the event. For instance, in a number of examples, event summarization can include a search and summarization framework to extract representative content from an unfiltered social media content stream for a number of aspects (e.g., topics) of each event. A temporal correlation feature, topic models, and/or content perplexity scores can be utilized in event summarization.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N”, “P,” “R”, and “S” particularly with respect to reference numerals in the drawings, indicate that a number of the particular feature so designated can be included with a number of examples of the present disclosure. Also, as used herein, “a number of” an element and/or feature can refer to one or More of such elements and/or features.

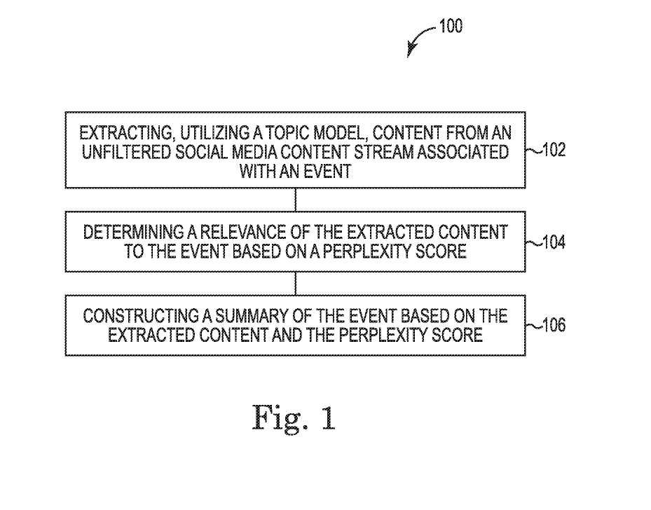

FIG. 1 is a block diagram illustrating an example of a method 100 for event summarization according to the present disclosure. Event summaries according to the present disclosure can include, for example, summaries to cover a broad range of information, summaries that report facts rather than opinions, summaries that are neutral to various communities (e.g., political factions), and summaries that can be tailored to suit an individual's beliefs and knowledge.

At 102, content (e.g., social media content) from an unfiltered social media content stream (e.g., an unfiltered Twitter stream, unfiltered Facebook posts, etc) associated with an event can be extracted utilizing a topic model. A topic model can include, for instance, a model for discovering topics and/or events that occur in the unfiltered media stream. For example the topic model can include a topic model that considers a decay parameter and/or a temporal correlation parameter, as will be discussed further herein.

In a number of examples, content can include a tweet on Twitter, a Facebook post, and/or other social media content associated with an event (e.g., an event of interest). For instance, given an event e and an unfiltered social Media content stream D (e.g., an unfiltered Twitter stream.), an amount K of content (e.g., a number of tweets) can be extracted from unfiltered social media content stream D to form a summary Sₑ, such that each content (e.g., piece of content) d∈a Sₑ covers a number of aspects of the event e, where K is a choice of parameter that can be chosen (e.g., by a human reader) with larger K values giving more information as compared to smaller K values.

The amount K of extracted content may have a particular relevance (e.g., related to, practically applicable, socially applicable, about, associated with, etc.) to the event. At 104, the relevance of the extracted content to the event is determined based on a perplexity score. A perplexity score can measure a likelihood that content is relevant to and/or belongs to the event and can comprise an exponential of a log likelihood normalized by a number of words in the extracted content, as will be discussed further herein. In a number of examples, determining the relevance of the extracted content comprises determining a relevance of the extracted content based on the perplexity score and/or a temporal correlation (e.g., utilizing a time stamp of the extracted content) between portions of the extracted content.

At 106, a summary of the event can be constructed based on the extracted content and the perplexity score. In a number of examples, constructing the summary can comprise determining a most relevant content (e.g., piece of content) from the extracted content and constructing the summary based on the most relevant piece of content, wherein the constructed summary comprises a portion of the most relevant piece of content (e.g. a portion of the extracted content).

For example, the constructed summary can include, for example, a single representative content (e.g., a single tweet) that is the most relevant to an event and/or a combination of content (e.g., a number of tweets, words extracted from particular tweets, etc.). The summary can also include a number of different summaries relating to a number of aspects (topics) of the event. For example, an event of interest may include a baseball game with a number of aspects, including a final score, home runs, stolen bases, etc. Each aspect of the baseball game event can have a summary, and/or the overall event can have a summary, for instance.

Summarization of events according to the present disclosure can allow for measuring different aspects of the event e from unfiltered social media content stream D. However, when analyzing unfiltered social media content streams, challenges may arise including the following, for example: words may be misspelled in content such that a dictionary or knowledge-base (e.g., Freebase, Wikipedia, etc.) cannot be used to find words that are relevant to event e; a majority of content in the unfiltered content stream D may be irrelevant to event e, causing unnecessary computation on a majority of the content; and content may be very short and can cause poor performance. To overcome these challenges, analysis can be narrowed to content sets (e.g., sets of tweets) relevant to event e, and perform topic modeling on this set of relevant content Dₑ.

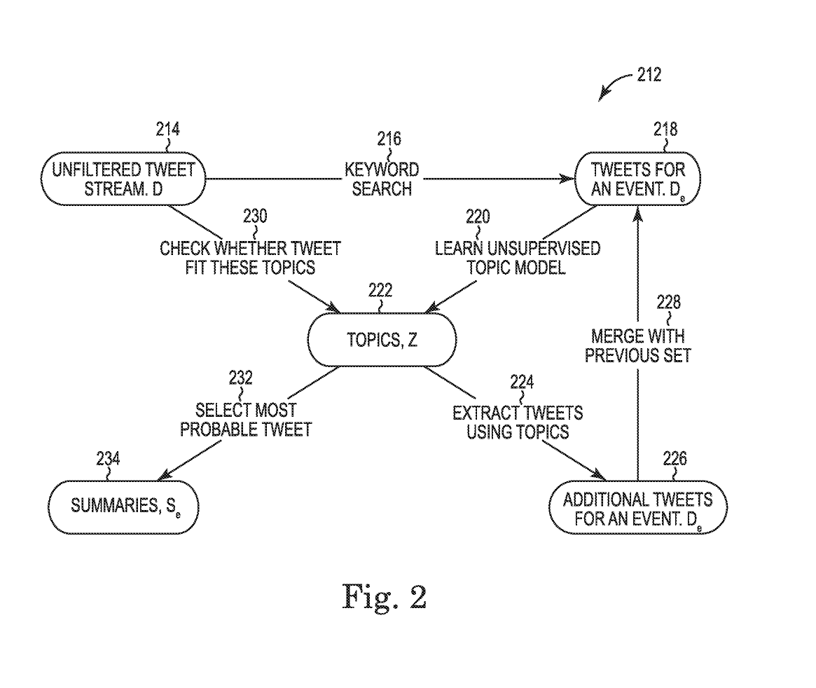

FIG. 2 is a block diagram illustrating an example of a method 212 for event summarization according to the present disclosure. The example illustrated in FIG. 2 references tweets, but any social media can be utilized. Method 212 includes a framework that addresses narrowing the analysis and performing topic modeling on the set of relevant content. To summarize the event of interest a from the unfiltered social media stream D (e.g., unfiltered Tweet stream 214), it can be assumed that there is a set of queries Q, wherein each query q∈Q q is defined by a set of keywords For example, a set of queries for an event “Facebook IPO” may include {{facebook, ipo}, {fb, ipo}, {facebook, initial, public, offer}, {fb, initial, public, offer}, {facebook, initial, offering}, {fb, initial, public, offering}}.

A keyword-based search (e.g., a keyword-based query Q) can be applied at 216 on the unfiltered social media content stream D 214 to obtain an initial subset 218 of relevant content Dₑ¹ for the event e. For instance, from unfiltered social media stream D, content (e.g., tweets) relevant to an event e can be extracted, such that a relevant piece of content includes content that matches at least one of the queries q∈Q. A piece of content, for example, matches a query q if it contains a number (e.g., all) of the keywords in q.

In a number of examples, a number of the words in the content may contribute little or no information to the aspects of the event e. In order to avoid processing on the unnecessary words in the content (unfiltered or extracted), in a number of examples, stop-words (e.g., and, a, but, how, or, etc.) can be removed, and only noun phrases may be considered by applying a Part-of-Speech Tagger to extract noun phrases. The noun phrases in the pieces of content can be modeled using a noun phrases for the Latent Dirichlet Allocation Model (NP+LDA), for example.

A topic model can be applied to content subset Dₑ¹ at 220 to obtain topics Z 222 (e.g., aspects, other keywords that describe various aspects of event e, etc.), which can result in an increased understanding of different aspects in the content Dₑ¹, as compared to an understanding using just the keyword search at 216. The topic model applied can include, for instance, a Decay Topic Model (DTM) and/or a Gaussian Decay Topic Model (GDTM), as will be discussed further herein. The use of the topic model at 220 can be referred to as, for example, “learning an unsupervised topic model.”

In response to finding the topics Z from the set of content (e.g., relevant tweets) Dₑ¹, additional content (e.g., additional tweets) Dₑ² can be extracted from the unfiltered social media content stream D using a model (e.g., GDTM). For instance, using the obtained topics Z 222, a different subset of content Dₑ² 2226 (e.g., additional tweets for event e) can be extracted at 224. In a number of examples, content relevant to the event can be extracted any number of times. For example, this extraction can be performed multiple times, and a topic model can be continuously refined as a result.

The content Dₑ² can be relevant to the event e, but in a number of examples, may not contain the keywords given by the query Q at 216. For example, “top-ranked” (e.g., most relevant) words in each topic z∈Z can give additional keywords that can be used to describe various aspects of the event e. The additional keywords, and in turn additional content sets (e.g., additional set of tweets Dₑ²) can be obtained by finding content d∈D that is not present in Dₑ¹ by selecting those with a high perplexity score (e.g., a perplexity score above a threshold) with respect to the topics, as will be discussed further herein.

At 228, the subsets of content Dₑ¹ and Dₑ² can be merged, and the merged content D_{B}=Dₑ¹∪Dₑ² can be used to find additional aspects of the event e. For example, merging subsets Dₑ¹ and Dₑ² can improve upon topics for the event e. Merging the content can improve the coverage on a content conversation, which can result in a more relevant and informative topic model (e.g., more relevant and informative GDTM).

From each of the topics z∈Z , event e can be summarized (e.g., as a summary within summaries Sₑ at 234) by selecting the content d from each topic z that gives the “best” (e.g., lowest) perplexity score (e.g., the most probably content at 232). At 230, content from unfiltered social media content stream D 214 can be “checked” to see if the content fits any of the topics Z. For example, content from unfiltered social media content stream D 214 can be filtered using topic Z already computed to learn if the content is relevant.

Content within content subsets Dₑ¹ and Dₑ² (e.g., tweets) may be written in snippets of as few as a single letter or a single word making a relevance determination challenging. However, content from different sources (e.g., different tweets, different Facebook posts, content across different social media) associated with (e.g., relevant to) an event e may be written around the same time period. For example, if an event happens at time A, a number of pieces of content may be written at or around the time of the event (e.g., at or around time A). A time stamp on the content (e.g., a Twitter time stamp) can be utilized to determine temporal correlations. In a number of examples of the present disclosure, content can be observed such that the content (e.g., content of tweets) for an event e in a sequence can be related to the content written around the same time. That is, given three pieces of content d₁, d₂, d₃∈Dₑ, that are written respectively at times t₁, t₂, t₃, where t₁<t₂<t₃, then a similarity between d₁ and d₂ may be higher than a similarity between d₁ and d₃,

In addition or alternatively, a trend of words written by Twitter users for an event “Facebook IPO” can be considered. In the example, the words {“date”, “17”, “may”, “18”} may represent the topic of Twitter users discussing the launch date of “Facebook IPO”. The words “date” and “may” may show increases around the same period of time. The word (e.g., number) “17” may have a temporal co-occurrence with “date” and “may”. As a result, it may be inferred, for example, that this set of words {“date”, “17”, “may”} belongs to the same topic. By assuming that content written around the same time is similar in content, the content subsets can be sorted in an order such that content written around the same time can “share” words from other content to compensate for their short length.

In a number of examples, to determine a temporal correlation between social media content, a DTM can be utilized, which can allow for a model that better learns posterior knowledge about content within subsets Dₑ¹ and Dₑ² written at a later time given the prior knowledge of content written at an earlier time as compared to a topic model without a decay consideration. For instance, this prior knowledge with respect to each topic z can decay with an exponential decay function with time differences and a decay parameter δ_{z} for each topic z∈Z.

By assuming that the time associated with each topic z is distributed with a Gaussian distribution G_{z}, the decay parameters δ_{z} can be inferred using the variance of Gaussian distributions. For example, if topic z has an increased time variance as compared to other topics, it may imply that the topic “sticks” around longer and should have a smaller decay, while topics with a smaller time variance may lose their novelty faster and should have a larger decay. In a number of examples, by adding the Gaussian components to the topic distribution, the GDTM can be obtained.

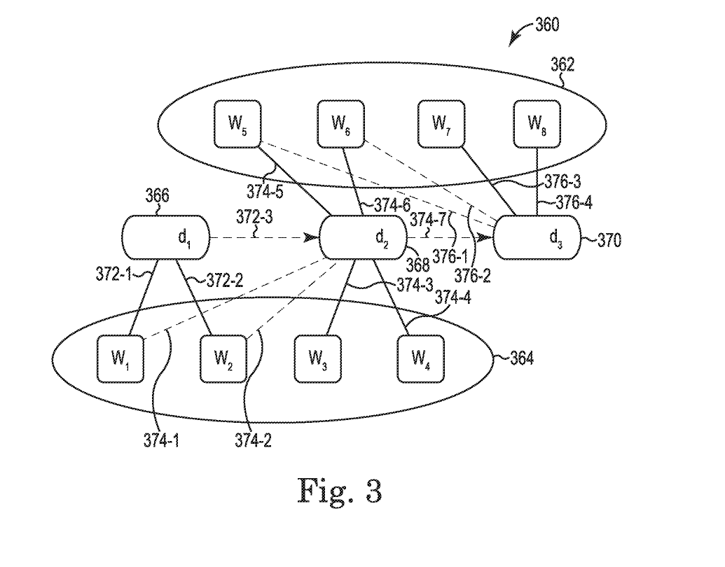

FIG. 3 is a block diagram 360 illustrating an example of topic modeling according to the present disclosure. Topic modeling can be utilized, for example, to increase accuracy of event summarization. Content d₁, d₂, and d₃ can include, for example, tweets, such that tweet d₂ is written after tweet and tweet d₃ is written after tweet d₂. Words (or letters, symbols, etc.) included in tweet d₁ can include words w₁ and w₂, as illustrated by lines 372-1 and 372-2,. respectively. Words included in tweet d₂ can include words W₃w₄, w₅, and w₆, as illustrated by lines 374-3, 374-4, 374-5, and 374-6, respectively. Words included in tweet d₃ can include w₇ and w₈, as illustrated by lines 376-3 and 376-4, respectively. Words w₁, w₂, w₃, and w₄ may be included in a topic 364 and words w₅, w₆, w₇, and w₈ may be included in a different topic 362. In a number of examples, words included in content or topics can be more or less than illustrated in the example of FIG. 3.

In a number of examples, tweet d₂ can inherit a number of the words in tweet d₁ shown by lines 372-3, 374-1, and 374-2 Similarly, tweet d₃ can inherit some of the words written by d₂ as shown by lines 376-1, 376-2, and 374-7. The inheritance may or may not be strictly binary, as it can be weighted according to the time difference between consecutive content (e.g., consecutive tweets). In a number of examples, the inheritance can be modeled using an exponential decay function (e.g., DTM, GDTM). Because of such inheritance between content, sparse data can appear to be dense after the inheritance and can improve the inference of topics from content.

In a number of examples, topic modeling can include utilizing a topic model (e.g., a DTM) that allows for content (e.g., tweets) to inherit the content of previous content (e.g., previous tweets). In such a model, each piece of content can inherit the words of not just the immediate piece of content before it, but also all the content before it subjected to an increasing decay when older content is inherited.

A DTM can avoid inflation of content subsets due to duplicative words, unnecessary repeated computation for inference of the duplicated words, and a snowball effect of content with newer time stamps inheriting content of all previous content. In a number of examples, the DTM can avoid repeated computation and can decay the inheritance of the words such that the newer content does not get overwhelmed by the previous content.

For instance, in a number of examples, the DTM can address repeated computation by the use of the topic distribution for each piece of content. Since topic models summarize the content of tweets in latent space using a K (e.g., number of topics) dimensional probability distribution, the model can allow for newer content to inherit the distribution of this probability distribution instead of words. The DTM can address improper decay by utilizing an exponential decay function for each dimension of the probability distribution.

The DTM can include a generative process; for example, each topic z can sample the prior word distribution from a symmetric Dirichlet distribution,

φ_{z}˜Dir(β).

The first content d₁∈D samples the prior topic distribution from a symmetric Dirichlet distribution,

θ_{d}¹˜Dir(α).

For all other content dₙ∈Dₑ samples the prior topic distribution from an asymmetric Dirichlet distribution,

$${θ}_{{d}_{n}} \sim Dir ( \{ α + {\sum }_{i = 1}^{n - 1} {p}_{i , z} * {exp [ - {δ}_{z} ( {t}_{n} - {t}_{i} ) \}}_{z ∈ Z} ) ,$$

where p_{i,z} is the number of words in tweet dᵢ that belong to topic z and δ_{z} is the decay factor associated with topic z. The larger the value of δ_{z}, the faster the topic z loses its novelty. Variable tᵢ can be the time that tweet dᵢ is written. The summation can sum over all the tweets [1, n-1] that are written before tweet dₙ. Each p_{i,z} can be decayed according to a time difference between tweet dₙand tweet dᵢ. Although the summation seems to involve an O(n) operation, the task can be made O(1) via memorization.

The DTM generative process can include content d sampling a topic variable Z_{d,np} for noun phrase np from a multinomial distribution using θ_{d} as parameters, such that:

z_{d,np}˜Multi(θ_{d}).

The words wₙₚ in noun phrase np can be sampled for the content d using topic variable z_{d,np} and the topic word distribution θ_{z} such that:

$$\begin{matrix}P ( {w}_{n , p} \vert {z}_{d , np} = k , φ ) = {\prod }_{v ∈ np} P ( {w}_{n , p , v} \vert {z}_{d , np} = k , {φ}_{k} ) \\ = {\prod }_{v ∈ np} {φ}_{k , v} .\end{matrix}$$

An expected value E_{day}(z) of topic z for a day (bin) can be determined for example as:

$${E}_{day} ( z ) = {\sum }_{d ∈ {D}_{day}} {θ}_{d , z} ,$$

where D_{day} can represent content (e.g., a set of tweets) in a given day.

In a number of examples, to observe a smoother transition of topics between different times, a second model (e.g., a GDTM) can be utilized instead of a DTM. The GDTM can include additional parameters to the topic word distributions (e.g., over and above the DTM parameters) to model the assumption that words specific to certain topics have an increased chance of appearing at specific times.

In a number of examples, the generative process for the GDTM can follow that of the DTM with the addition of a time stamp generation for each noun phrase. For example, in addition to topic word distribution θ_{z}, each topic z can have an additional topic time distribution G_{z} approximated by the Gaussian distribution with mean μ_{z} and variance σ_{z}², such that,

G_{z}˜N(θ_{z}, σ_{z}²).

The time t for a noun phrase np can be given by:

$$P ( {t}_{np} \vert z , {G}_{z} ) = \frac{1}{\sqrt{2 {πσ}_{z}^{2}}} exp ( - \frac{{( {t}_{np} - {μ}_{z} )}^{2}}{2 {σ}_{z}^{2}} ) .$$

In a number of examples, every topic z can be associated with a Gaussian distribution G_{z}, and as a result, the shape of the distribution curve can be used to determine decay factors δ_{z}, ∀_{z}∈Z. The delta_{z} which may have been previously used for transferring the topic distribution from previous content to subsequent contents can depend on variances of the Gaussian distributions. Topics with smaller variance σ_{z}² may imply that they have a shorter lifespan and may decay quicker (larger delta_{z}), while topics with larger variance may decay slower giving it a smaller delta_{z}.

A half-life concept can be used to estimate a value of decay factor δ_{z}. Given that it may be desirable to find the decay value δ that causes content (e.g., a tweet) to discard half of the topic from previous content (e.g., a previous tweet), the following may be derived:

$$exp ( - δ * ( {t}_{n} - {t}_{n - 1} ) ) = 0.5$$

$$δ * Δ T = log 2$$

$$δ = \frac{log 2}{Δ T} .$$

In a Gaussian distribution with an arbitrary mean and variance, the value of ΔT can be affected by the variance (e.g., width) of the distribution. To estimate ΔT, let ΔT=τΔt where τ is a parameter and Δt is estimated as follows:

$$\frac{P ( 0 )}{P ( Δ t )} = \frac{2 p}{p}$$

$$\frac{exp ( 0 )}{exp ( - \frac{{( Δ t )}^{2}}{2 {σ}^{2}} )} = 2$$

$$\frac{{( Δ t )}^{2}}{2 {σ}^{2}} = log 2$$

$$Δ t = \sqrt{2 {σ}^{2} log 2} .$$

In a number of examples, δ can be given by:

$$δ = \frac{log 2}{τ \sqrt{2 {σ}^{2} log 2}} ,$$

where the larger the variance σ², the smaller the decay δ and vice versa.

Alternatively and/or additionally to the DTM and GDTM, a perplexity score determination can be utilized to extract content from the unfiltered social media stream, determine additional related content, and the perplexity score can be used in an event summarization determination.

In a number of examples, query expansion can be performed by using particular words (e.g., the top words in a topic) for a keyword search. A perplexity score can be determined for each piece of content d∈D, d∉Dₑ¹. Content relevant to event e can be ranked n ascending order with a lower perplexity being more relevant to event e and a higher perplexity score being less relevant to event e. Using the perplexity score instead of keyword search from each topic may allow for differentiation between the importance of different content using inferred probabilities.

The perplexity score of content d can be given by the exponential of the log likelihood normalized by the number of words in a piece of content (e.g., number of words in a tweet):

$$perplexity ( d ) = exp ( \frac{- log P ( d \vert θ , φ , G )}{{N}_{d}} ) ,$$

where N_{d} is the number of words in content d. Because content with fewer words may tend to have a higher inferred probability and hence a lower perplexity score, N_{d} is normalized to favor content with more words.

Using the topics learned from the set of relevant content Dₑ, a representative piece of content from each topic (e.g., the most representative tweet from each topic) can be determined to summarize the event e. To determine the most representative content for topic z, the perplexity score can be computed with respect to topic z for content d∈Dₑ, and a piece of content (e.g., a tweet) with the lowest perplexity score with respect to z can be chosen to use in a summarization of event e. For example,

$$perplexity ( d , z ) = exp ( \frac{- log P ( d , z \vert θ , {φ}_{z} , {G}_{z}}{{N}_{d}} ) .$$

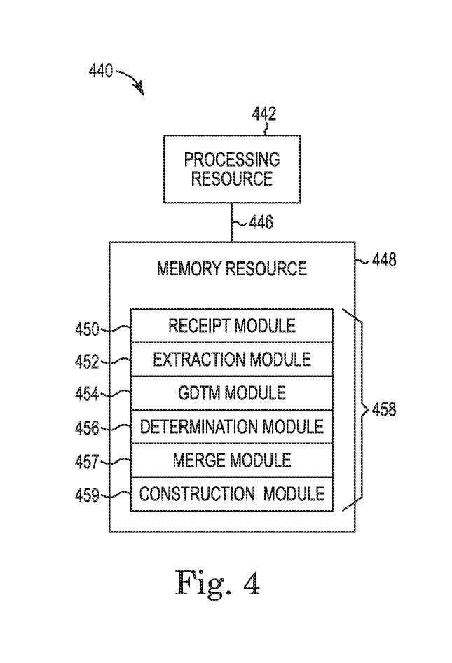

FIG. 4 illustrates a block diagram of an example of a system 440 according to the present disclosure. The system 440 can utilize software, hardware, firmware, and/or logic to perform a number of functions.

The system 440 can be any combination of hardware and program instructions configured to summarize content. The hardware, for example can include a processing resource 442, a memory resource 448, and/or computer-readable medium (CRM) (e.g., machine readable medium (MRM), database, etc.) A processing resource 442, as used herein, can include any number of processors capable of executing instructions stored by a memory resource 448. Processing resource 442 may be integrated in a single device or distributed across devices. The program instructions (e.g., computer-readable instructions (CRI)) can include instructions stored on the memory resource 448 and executable by the processing resource 442 to implement a desired function (e.g., determining a counteroffer).

The memory resource 448 can be in communication with a processing resource 442. A memory resource 448, (e.g., CRM) as used herein, can include any number of memory components capable of storing instructions that can be executed by processing resource 442, and can be integrated in a single device or distributed across devices. Further, memory resource 448 may be fully or partially integrated in the same device as processing resource 442 or it may be separate but accessible to that device and processing resource 442.

The processing resource 442 can be in communication with a memory resource 448 storing a set of CRI 458 executable by the processing resource 442, as described herein. The CRI 458 can also be stored in remote memory managed by a server and represent an installation package that can be downloaded, installed, and executed. Processing resource 442 can be coupled to memory resource 448 within system 440 that can include volatile and/or non-volatile memory, and can be integral or communicatively coupled to a computing device, in a wired and/or a wireless manner. The memory resource 448 can be in communication with the processing resource 442 via a communication link (e.g., path) 446.

Processing resource 442 can execute CRI 458 that can be stored on an internal or external memory resource 448. The processing resource 442 can execute CRI 458 to perform various functions, including the functions described with respect to FIGS. 1-3.

The CRI 458 can include modules 450, 452, 454, 456, 457, and 459. The modules 450, 452, 454, 456, 457, and 459 can include CRI 458 that when executed by the processing resource 442 can perform a number of functions, and in some instances can be sub-modules of other modules. For example, the receipt module 450 and the extraction module 452 can be sub-modules and/or contained within the same computing device. In another example, the number of modules 450, 452, 454, 456, 457, and 459 can comprise individual modules at separate and distinct locations (e.g., CRM etc.).

In a number of examples, modules 450, 452, 454, 456, 457, and 459 can comprise logic which can include hardware (e.g., various forms of transistor logic, application specific integrated circuits (ASICs), etc.), as opposed to computer executable instructions (e.g., software, firmware, etc.) stored in memory and executable by a processor.

In some examples, the system can include a receipt module 450. A receipt module 450 can include CRI that when executed by the processing resource 442 can receive a set of queries, wherein each query in the set of queries is defined by a first set of keywords associated with an event. In a number of examples, the event comprises a concept of interest targeted by a user of the social media (e.g., a user using social media, a user observing social media, etc.). For example, a particular user may choose a targeted topic to summarize.

An extraction module 452 can include CRI that when executed by the processing resource 442 can extract, from an unfiltered social media content stream, a first subset of social media content that matches a first query within the set of queries. Content, for example, matches a query q if it contains a number of (e.g., all) the keywords in q.

A GDTM module 454 can include CRI that when executed by the processing resource 442 can apply a GDTM to the first subset of social media content to determine a second set of keywords associated with the event. In a number of examples, the GDTM considers a temporal correlation (e.g., utilizing time stamps of the first subset of social media content) between portions of content in the first subset of social media content and applies a decay parameter to a topic within the first subset of social media content.

A determination module 456 can include CRI that when executed by the processing resource 442 can determine a second subset of social media content based on the second set of keywords and a computed perplexity score, wherein the perplexity score is computed for each portion of social media content extracted from the unfiltered social media content stream not included in the first subset of social media content.

A merge module 457 can include CRI that when executed by the processing resource 442 can merge the first subset of social media content and the second subset of social media content. The merged content can be used to find additional aspects of the event e.

A construction module 459 can include CRI that when executed by the processing resource 442 can construct a summary of the event based on the merged subsets and a perplexity score of social media content within the merged subsets. The constructed event summary can include, for instance, a search extracted representative content from the unfiltered social media content stream for a number of aspects (e.g., topics) of the event. The constructed summary can cover a broad range of information, report facts rather than opinions, can be neutral to various communities (e.g., political factions), and can be tailored to suit an individual's beliefs and knowledge.

In some instances, the processing resource 442 coupled to the memory resource 448 can execute CRI 458 to extract a first set of social media content relevant to an event from an unfiltered stream of social media content utilizing a keyword-based query; extract a second set of social media content relevant to the event from the unfiltered stream of social media content utilizing topic modeling applied to the first set of social media content; and construct a summary of the event utilizing the first set of social media content and the second set of social media content. In a number of examples, the second set of social media content can comprise social media content not included in the first set of social media content. For example, the second set of social media content can comprise d∈D, d∉Dₑ¹. In a number of examples, a third, fourth, and/or any number of sets of social media content relevant to the event can be extracted from the unfiltered stream of social media content. For example, this can be performed multiple times, and a topic model can be continuously refined as a result.

The processing resource 442 coupled to the memory resource 448 can execute CRI 458 in a number of examples to merge the first set of social media content and the second set of social media content, wherein the merged content includes a number of topics associated with the event and summarize the event by selecting social media content from each of the number of topics that results in a lowest perplexity score with respect to each of the number of topics. In a number of examples, the perplexity score utilized in the event summarization comprises a measure of a likelihood that the social media content from each of the number of topics is relevant to the event.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A non-transitory computer-readable medium storing a set of instructions executable by a processing resource to:
extract a first set of social media content relevant to an event from an unfiltered stream of social media content utilizing a keyword-based query;
extract a second set of social media content relevant to the event from the unfiltered stream of social media content utilizing topic modeling applied to the first set of social media content; and
construct a summary of the event utilizing the first set of social media content and the second set of social media content.

2. The non-transitory computer-readable medium of claim 1, wherein the event comprises a concept of interest that gains attention of a user of the social media.

3. The non-transitory computer-readable medium of claim 1, wherein the topic modeling comprises Gaussian decay topic modeling.

4. The non-transitory computer-readable medium of claim 1, wherein the set of instructions executable by the processing resource to construct a summary of the event comprise instructions executable to:
merge the first set of social media content and the second set of social media content, wherein the merged content includes a number of topics associated with the event; and
summarize the event by selecting social media content from each of the number of topics that results in a lowest perplexity score with respect to each of the number of topics.

5. The non-transitory computer-readable medium of claim 4, wherein the perplexity score comprises a measure of a likelihood that the social media content from each of the number of topics is relevant to the event.

6. The non-transitory computer-readable medium of claim 1, wherein the second set of social media content comprises social media content not included in the first set of social media content.

7. A computer-implemented method far event summarization, comprising:
extracting, utilizing a topic model, content from an unfiltered social media content stream associated with an event;
determining a relevance of the extracted content to the event based on a perplexity score of the extracted content; and
constructing a summary of the event based on the extracted content and the perplexity score.

8. The computer-implemented method of claim 7, wherein constructing the summary of the event comprises:
determining a most relevant piece of content from the extracted content; and
constructing the summary based on the most relevant piece of content, wherein the constructed summary comprises a portion of the most relevant piece of content.

9. The computer-implemented method of claim 7, wherein determining the relevance of the extracted content comprises determining a relevance of the extracted content based on a temporal correlation between portions of the extracted content.

10. The computer-implemented method of claim 9, wherein determining the relevance of the extracted content based on the temporal correlation between portions of the extracted content comprises utilizing a time stamp of the extracted content.

11. The computer-implemented method of claim 7, wherein the constructed summary comprises portions of the extracted content and is associated with a number of aspects of the event.

12. The computer-implemented method of claim 7, wherein the perplexity score comprises an exponential of a log likelihood normalized by a number of words in the extracted content.

13. A system, comprising:
a processing resource; and
a memory resource communicatively coupled to the processing resource containing instructions executable by the processing resource to:
receive a set of queries, wherein each query in the set of queries is defined by a first set of keywords associated with an event;
extract, from an unfiltered social media content stream, a first subset of social media content that matches a first query within the set of queries;
apply a Gaussian decay topic model to the first subset of social media content to determine a second set of keywords associated with the event;
determine a second subset of social media content based on the second set of keywords and a computed perplexity score, wherein the perplexity score is computed for each portion of social media content extracted from the unfiltered social media content stream not included in the first subset of social media content;
merge the first subset of social media content and the second subset of social media content: and
construct a summary of the event based on the merged subsets and perplexity score of social media content within the merged subsets.

14. The system of claim 13, wherein the Gaussian decay topic model considers a temporal correlation between portions of content in the first subset of social media content and applies a decay parameter to a topic within the first subset of social media content.

15. The system of claim 13, wherein the event comprises a concept of interest targeted by a user of the social media.
